(19) United States
(12) Patent Application Publication
(10) Pub. No.: US 2008/0018220 A1
(43) Pub. Date: Jan. 24, 2008

(54) High-performance negative ion generating module

(76) Inventor: Kun-Liang Hong, Chungho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/705,019

(22) Filed: Feb. 12, 2007

(30) Foreign Application Priority Data
Jul. 24, 2006 (CN) 200620122705.1

(51) Int. Cl. H01J 3/04

(52) U.S. Cl. 313/359.1

(57) ABSTRACT

A high-performance negative ion generating module includes a high-voltage electric field catalyzer unit formed of multiple catalyzer reaction boards and two high-voltage discharging panels for discharging a high voltage to produce a high voltage electric field, and an ion generator kit formed of a first ion generating panel, which has activation tubes respectively coated with VO₂ and TiO₂, and a metal coating and electrically connected to the negative pole of the power supply, and a second ion generating panel, which has discharging terminals electrically connected to the positive pole of the power supply and respectively aimed at the activation tubes for causing an electron wind to flow through the activation tubes to enhance air cleaning.

### BACKGROUND OF THE INVENTION

1. Field of the Invention

The present invention relates to negative ion generators and more particularly, to a high-performance negative ion generating module comprised of a high-voltage electric field catalyzer unit and an ion generator kit.

2. Description of the Related Art

Various negative ion generating devices have been disclosed and have appeared on the market. These conventional negative ion generating devices require much time to generate sufficient amount of negative ions to clean air. Further, these conventional negative ion generating devices consume much electricity during working. There are known negative ion generating devices that have a catalytic converter panel installed in the discharging side of the negative ion generating unit to accelerate the reaction time of the electric field and to convert static electricity around the discharging unit into negative ions. The use of the catalytic converter panel does not provide a significant improvement on the generation of negative ions.

Therefore, it is still desirable to provide a negative ion generating device that generates negative ions efficiently.

### SUMMARY OF THE INVENTION

The present invention has been accomplished under the circumstances in view. It is one object of the present invention to provide a high-performance negative ion generating module, which saves consumption of electricity. It is another object of the present invention to provide a high-performance negative ion generating module, which kills germs, decomposes solvent, and removes mildew and bad smell and carbon monoxide efficiently. It is still another object of the present invention to provide a high-performance negative ion generating module, which is easy to install.

According to one aspect of the present invention, the high performance negative ion generating module uses a high-voltage electric field catalyzer unit formed of multiple catalyzer reaction boards and two high-voltage discharging panels for discharging a high voltage to produce a high voltage electric field that accelerates electrons, causing collision between molecules, and therefore secondary electrons, ions, and free radicals are emitted. Emitted electrons keep striking air molecules to emit a big amount of electrons (Avalanche Effect), and electrons keep striking molecules to emit free radicals, thereby causing a chemical reaction, and therefore high reactive free radicals such as OH⁻ and O₂⁻ are continuously produced at the presence of air containing O₂, N₂, H₂O, etc. By means of the catalysis of the catalyzer reaction boards to lower activation energies, reaction rates are enhanced. Therefore, corona effect in combination with catalyzer enhances removal of VOCs (Volatile organic compounds) such as carbon tetrachloride, benzene, ketone, trichloroethylene, toluene, butyl acetate, and etc.

According to another aspect of the present invention, the high performance negative ion generating module uses an ion generator kit formed of a first ion generating panel, which has activation tubes respectively coated with VO₂ and TiO₂, and a metal coating and electrically connected to the negative pole of the power supply, and a second ion generating panel, which has discharging terminals electrically connected to the positive pole of the power supply and respectively aimed at the activation tubes for causing an electron wind to flow through the activation tubes to enhance air cleaning.

According to still another aspect of the present invention, the activation tubes of the first ion generating panel each have a hollow cylindrical structure, and the discharging terminals of the second ion discharging panel are respectively axially aimed at the central axis of each of the activation tubes so that an electron wind is produced at the output side of the ion generator kit for causing emitting of a big amount of evenly distributed negative ions upon supply of electricity to the ion generating module. This arrangement saves consumption of power supply while emitting a big amount of negative ions.

According to still another aspect of the present invention, the high-performance negative ion generating module further comprises a housing that houses the high-voltage electric field catalyzer unit and the ion generating kit. The housing has vertical insertion grooves bilaterally symmetrically disposed on the inside and extending in vertical direction for the insertion of the catalyzer reaction boards, the high-voltage discharging panels, and the ion discharging panels. Therefore, the installation of the high-performance negative ion generating module is simple.

### BRIEF DESCRIPTION OF THE DRAWINGS

FIG. 1 is an exploded view of a high performance negative ion generating module according to the present invention.

FIG. 2 is a perspective assembly view of the high performance negative ion generating module according to the present invention.

FIG. 3 is a sectional side view of the high performance negative ion generating module according to the present invention.

FIG. 4 is a sectional end view of the high performance negative ion generating module according to the present invention.

### DETAILED DESCRIPTION OF THE PREFERRED EMBODIMENT

Referring to FIGS. 14, a high performance negative ion generating module in accordance with the present invention is shown comprising a housing 1 that houses a high-voltage electric field catalyzer unit and an ion generator kit.

The housing 1 has a top cover 13 covered on the top open side, and a plurality of vertical insertion grooves 11 symmetrically formed on the inner wall of each of the two opposite vertical side panels thereof and vertically extending to the top open side.

The aforesaid high-voltage electric field catalyzer unit comprises a plurality of catalyzer reaction boards 3 inserted into the vertical insertion grooves 11 and kept in parallel inside the housing 1, and two high-voltage discharging panels 31 and 32 inserted into the vertical insertion grooves 11 and arranged in parallel at two opposite sides relative to the catalyzer reaction boards 3. The high-voltage discharging panels 31 and 32 each have a high-voltage discharging terminal 311 and a grounding terminal 321. When the high-voltage discharging terminals 311 of the high-voltage discharging panels 31 and 32 are discharging a high voltage, a high voltage electric field is produced. Under this environment, electrons are accelerated by the high voltage electric field, causing collision between molecules, and therefore secondary electrons, ions, or free radicals are emitted. Emitted electrons keep striking air molecules to emit a big amount of electrons (Avalanche Effect), and electrons keep striking molecules to emit free radicals, thereby causing a chemical reaction, and therefore high reactive free radicals such as OH⁻ and O₂⁻ are continuously produced at the presence of air containing O₂, N₂, H₂O, etc. By means of the catalysis of the catalyzer reaction boards 3 to lower activation energies, reaction rates are enhanced. Therefore, corona effect in combination with catalyzer enhances removal of VOCs (Volatile organic compounds) such as carbon tetrachloride, benzene, ketone, trichloroethylene, toluene, butyl acetate, and etc.

The aforesaid ion generator kit comprises a circuit board 14 mounted in a bottom chamber 12 inside the housing 1, and a set of ion generating panels 4 and 5 inserted into the vertical insertion grooves 11 inside the housing 1 and electrically connected to the circuit board 14. One ion generating panel 5 carries multiple activation tubes 51 respectively coated with a layer of nanometered VO₂, a layer of TiO₂, and a layer of silver coating (or gold coating or any of a variety of other metal coatings), and electrically connected to the negative terminal of the circuit board 14. The other ion generating panel 4 has a plurality of discharging terminals 41 electrically connected to the positive terminal of the circuit board 14 and respectively aimed at the multiple activation tubes 51. When a high voltage is discharging through the discharging terminals 41, the potential difference between the ion generating panels 4 and 5 causes an electron wind to flow through the multiple activation tubes 51, enhancing air cleaning, and at the same time the VO₂ and TiO₂ coatings enhance absorption of light and efficiency of catalysis (positive ions emitted from the metal coatings of the activation tubes are capable of decomposing odor gas). Therefore, the ion generating module of the present invention can kill germs, decompose solvent, and remove mildew and bad smell and carbon monoxide efficiently.

Further, an electric fan 2 is installed in the rear side of the housing 1 and controlled to cause currents of air to spread generated ions, and a fan guard 21 is covered on the rear open side of the housing 1 for allowing passing of outside air into the inside of the housing 1.

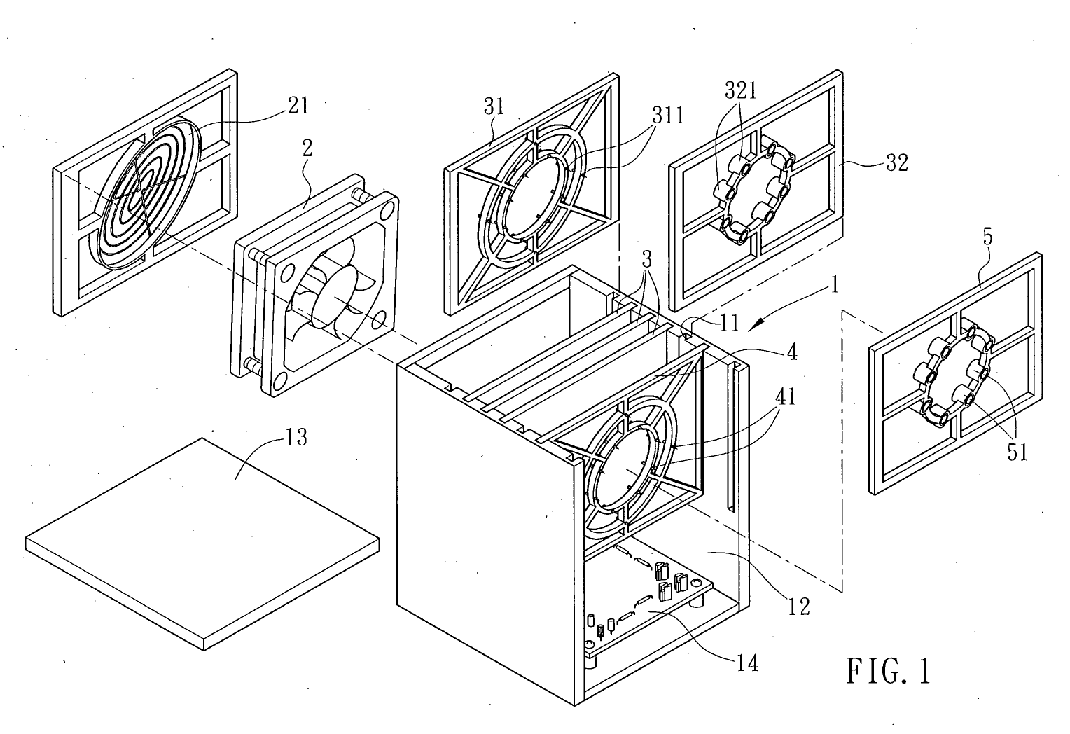

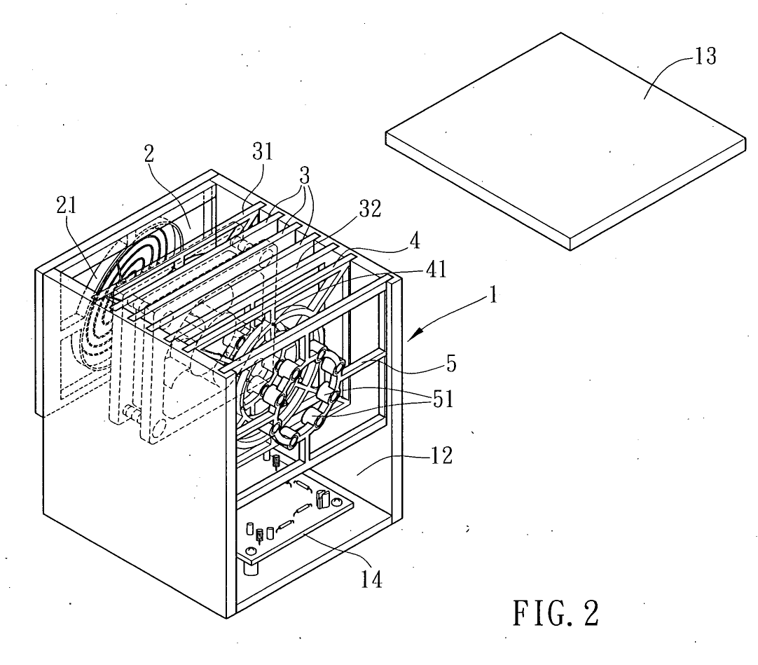

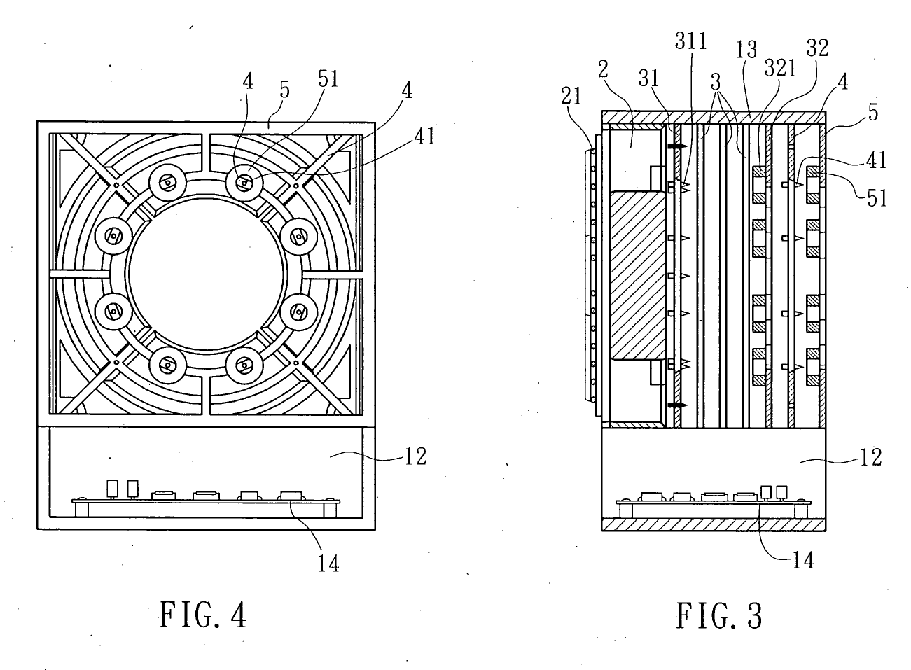

A prototype of high-performance negative ion generating module has been constructed with the features of FIGS. 1-4. The high-performance negative ion generating module functions smoothly to provide all the features discussed earlier.

Although a particular embodiment of the invention has been described in detail for purposes of illustration, various modifications and enhancements may be made without departing from the spirit and scope of the invention.

What the invention claimed is:

1. A high-performance negative ion generating module comprising:
a housing, said housing having a plurality of vertical insertion grooves symmetrically formed on an inner wall of each of two opposite vertical side panels thereof;
a high-voltage electric field catalyzer unit mounted inside said housing, said high-voltage electric field catalyzer unit comprising a plurality of catalyzer reaction boards inserted into the vertical insertion grooves of said housing and kept in parallel inside said housing, and two high-voltage discharging panels inserted into the vertical insertion grooves of said housing and arranged in parallel at two opposite sides relative to said catalyzer reaction boards, said high-voltage discharging panels each having a high-voltage discharging terminal for discharging a high voltage to produce a high voltage electric field and a grounding terminal; and
an ion generator kit mounted inside said housing, said ion generator kit comprising a first ion generating panel and a second ion generating panel respectively inserted into the vertical insertion grooves of said housing and respectively connected to negative pole and positive pole of a power supply, said first ion generating panel carrying multiple activation tubes respectively coated with a layer of nanometered VO, a layer of TiO₂, and a layer of metal coating and electrically connected to the negative pole of the power supply, said second ion generating panel having a plurality of discharging terminals electrically connected to the positive pole of the power supply and respectively aimed at said activation tubes such that when a high voltage is discharging through the discharging terminals of said second ion generating panel, the potential difference between said first ion generating panel and said second ion generating panel causes an electron wind to flow through said activation tubes to enhance air cleaning, and at the same time the VO and TiO₂ coatings of said activation tubes enhance absorption of light and efficiency of catalysis of said catalyzer reaction boards.

2. The high-performance negative ion generating module as claimed in claim 1, further comprising an electric fan installed in said housing and controlled to cause currents of air toward said high-voltage electric field catalyzer unit and said ion generator kit, and a fan guard covered on a rear open side of said housing for allowing passing of outside air into the inside of the housing toward said electric fan.

3. The high-performance negative ion generating module as claimed in claim 1, wherein said ion generator kit comprises a circuit board mounted in a bottom chamber inside said housing and electrically connected to said ion generating panels to provide a high voltage to said ion generating panels.
